(19) United States
(12) Patent Application Publication
(10) Pub. No.: US 2026/0259137 A1
(43) Pub. Date: Sep. 3, 2026

(54) DEVICE FOR AMPLIFYING A SIGNAL IN SELF-REFERENCE QUANTITATIVE PHASE IMAGING

(71) Applicants: SORBONNE UNIVERSITE, PARIS (FR); CENTRE NATIONAL DE LA RECHERCHE SCIENTIFIQUE, PARIS (FR); INSTITUT NATIONAL DE LA SANTE ET DE LA RECHERCHE MEDICALE - INSERM, PARIS (FR); UNIVERSITE PARIS CITE, PARIS (FR)

(72) Inventors: Pascal BERTO, PARIS (FR); Clémence GENTNER, PARIS (FR); Pierre BON, PARIS (FR); Gilles TESSIER, PARIS (FR); Benoit ROGEZ, PARIS (FR)

(73) Assignees: SORBONNE UNIVERSITE, PARIS (FR); CENTRE NATIONAL DE LA RECHERCHE SCIENTIFIQUE, PARIS (FR); INSTITUT NATIONAL DE LA SANTE ET DE LA RECHERCHE MEDICALE - INSERM, PARIS (FR); UNIVERSITE PARIS CITE, PARIS (FR)

(21) Appl. No.: 18/879,528

(22) PCT Filed: Jun. 30, 2022
(86) PCT No.: PCT/FR2022/051312

§ 371 Date: Jan. 10, 2025

(51) Int. Cl. G01N 21/45

(52) U.S. Cl. CPC G01N 21/45; G01N 2021/458

(57) ABSTRACT

Quantitative phase imaging device having an imaging optical system for imaging an object in an image plane, a light source for emitting light radiation over the Fourier plane of the imaging optical system, an optical spatial filter in the Fourier plane, having an area of least attenuation and an area of greatest attenuation, a wavefront sensor for measuring, in the image plane, the intensity and the phase of the light radiation which has passed through the imaging optical system and of which at least part has interacted with the object, in order to quantify the phase induced by the object, the light source, the imaging optical system and the optical spatial filter being such that, when the object is absent, the light radiation is focused on the area of greatest attenuation.

### TECHNICAL FIELD

The present invention relates to a quantitative phase imaging device, in particular for characterising nano-objects.

### PRIOR ART

When a transparent or semi-transparent object is observed in conventional transmission electron microscopy, i.e. in bright-field optical microscopy, the contrast observed in the image is generally low. This makes studying the object more complex, in particular when the object measures less than one micrometre.

Phase-contrast microscopy, developed by Frederik Zernike, is an imaging method that involves making use of the phase changes of a light wave passing through an object to be imaged. A disadvantage of phase-contrast microscopes is the halo they introduce into the image around the observed objects. Phase-contrast microscopy is based on a measurement of the intensity of the light wave and on the assumption that some of the phase information is transmitted in the intensity by interference phenomena. Thus, it has the major drawback that it does not quantify the phase of the wave, nor does it allow the intensity contribution to be isolated from the phase contribution. However, as described below, precisely measuring the phase is particularly important in many applications, in particular for studying micro-organisms or characterising nanoparticles.

Quantitative phase microscopy is another imaging method based on wavefront analysis of the light that illuminates and interacts with the object to be imaged. It measures the optical phase or a parameter proportional to this wave. In most cases, it measures the light intensity at the same time. Using an attached digital camera of diffractive, refractive or reflective optical elements, it measures a total field resulting from the sum of an incident field and a field scattered by the object, for example a semi-transparent, non-absorbent, low-scatter object.

Quantitative phase microscopy generates greater contrasts than those obtained in conventional microscopy for transparent or semi-transparent objects and thus allows smaller objects to be studied in more detail than in conventional microscopy. In particular, quantitatively measuring the phase makes it possible to access the density or mass measurement of an observed object.

### Quantitative Phase Microscopy Techniques Include:

“reference arm” techniques, which are based on measuring interference between a reference wave and a wave that has interacted with the object to be imaged, such as holography, and
self-reference techniques, which are based on a phase gradient measurement. In particular, the self-reference techniques may be implemented using a wavefront analyser that images the object. In particular, the wavefront analyser may be based on the use of an optical mask, e.g. a Hartmann hole array, a Shack-Hartmann lenslet array, a grating, a modified Hartmann mask, a diffuser or a metasurface, upstream of a camera.

Unlike reference arm techniques, which require complex and vibration-sensitive optical assemblies, self-reference quantitative phase imaging techniques are simple to implement and allow good phase sensitivity to be obtained.

Quantitative phase microscopy has many applications, especially in biology for imaging low-scatter sub-cellular components while obtaining characteristic biophysical values. However, observation at a molecular level is complex, if not impossible, because of the weak light-matter interaction of semi-transparent nano-objects.

Quantitative phase microscopy also makes it possible to detect and characterise nanoparticles or monitor chemical reactions. The detection limit of objects or material flows is directly dependent on the phase sensitivity of the method used.

Quantitative phase microscopy also makes it possible to map variations in the refractive index resulting from a thermal disturbance. It can thus map a temperature distribution to a micrometre-level spatial accuracy. Increasing the phase sensitivity would then allow the temperature sensitivity to be increased. This would also make it possible to more sensitively map changes in the refractive index resulting from an electrical, acoustic or magnetic disturbance.

In optical metrology, in particular for quality control in lithography or nanoprinting, quantitative phase microscopy allows the profile of a surface to be measured since the thickness variations induce a local variation in the measured phase shift. Good phase sensitivity is crucial for quantifying sub-nanometric thickness variations.

However, one flaw common to the known quantitative phase microscopy techniques is that the amplitude of the field scattered by the object(s) to be imaged is very small compared with the amplitude of the incident field. This then results in a weak phase signal, which makes it difficult to characterise nano-objects, even more so when they are in motion.

Modifications to the reference arm techniques have been proposed to try to overcome this drawback, but they remain complex to implement and are characterised by sensitivity that is limited by the vibrations of the reference arm of the optical assembly.

There is therefore a need to improve detectability in self-reference quantitative phase imaging techniques, i.e. to have a self-reference quantitative phase imaging technique capable of detecting at least one object, in particular a semi-transparent object and/or one measuring less than 100 nanometres, in particular a moving object of this kind, with a high degree of contrast.

### SUMMARY OF THE INVENTION

The invention proposes a quantitative phase imaging device comprising:
an imaging optical system for imaging an object in an image plane,
a light source for emitting light radiation over at least part of the Fourier plane of the imaging optical system,
an optical spatial filter extending in the Fourier plane of the imaging optical system and comprising an area in which the light radiation is attenuated to the least extent and an area in which the light radiation is attenuated to the greatest extent,
a wavefront sensor for measuring, in the image plane, the intensity and the phase of the electromagnetic field associated with the light radiation that was emitted by the light source, has passed through the imaging optical system and the optical spatial filter and of which at least part has interacted with the object, in order to quantify the phase induced by the object, the light source, the imaging optical system and the optical spatial filter being arranged so that, when the object to be imaged is absent, the light radiation is focused on the area of greatest attenuation.

The “Fourier plane” of the imaging optical system is the plane in which the Fraunhofer diffraction pattern, i.e. the Fourier transform of the object under study, can be observed. Thus, in the Fourier plane, the user of the device can visualise the spatial frequencies of the object under study. In a variant, the imaging optical system is telecentric, i.e. its entrance pupil or exit pupil is at infinity, and the Fourier plane coincides with a pupil plane of the imaging optical system. A “pupil plane” of the imaging optical system is a plane in which the pupil of the optical system, or an image of it formed by a part of the optical system, is observed.

When an object to be imaged by the imaging optical system is present, the incident light radiation that comes from the light source and is not diffracted and/or not scattered by the object is focused on the area of greatest attenuation on the spatial filter, while the light radiation that is diffracted and/or scattered by the object is localised at least in part on the area of least attenuation.

Thus, the optical spatial filter specifically attenuates the intensity of the incident light radiation that is not diffracted and/or scattered by the object while keeping the intensity of the radiation diffracted and/or scattered by the object virtually unchanged outside the area of greatest attenuation. The invention makes it possible to attenuate the contribution of the incident electromagnetic field, which is associated with the incident light radiation emitted by the light source and not diffracted and/or scattered by the object, to the electromagnetic field detected by the wavefront sensor, thereby amplifying the phase signal. On the basis of the phase and intensity measurement, and by taking account of the complex transmittance of the areas of greater and least attenuation, an analytical model or digital processing makes it possible to determine the quantified value of the phase which would be measured if the optical spatial filter were not present, with an increased signal-to-noise ratio. It is thus possible to calculate relevant quantitative parameters, such as the dry mass of the object, the index value of the object or the thickness of the object, from this quantified value of the phase.

The areas of greater and least attenuation preferably affect the phase of the wave differently.

The “area of greatest attenuation” induces an attenuation in the wavelength(s) making up the light radiation emitted by the light source that, as a rule, is lower than the “area of least attenuation”.

### Wavefront Sensor

The wavefront sensor measures at least one variation, in particular a gradient, of the phase of the light radiation that has passed through the object, the imaging optical system and the optical spatial filter, or a characteristic parameter of said phase such as the optical path difference travelled by two light rays. The phase induced by the object can be determined from the characteristic parameter by integrating the measured gradient.

The wavefront sensor furthermore measures the intensity of said radiation.

The wavefront sensor preferably comprises a light radiation detector, for example a camera, and in particular comprises a two-dimensional sensor for sampling the intensity. Optionally, the wavefront sensor comprises a wavefront analysis mask arranged in front of the detector along the optical path of the light radiation, in order to determine the spatial distribution of the gradient of the phase of the light radiation or of a signal proportional to said phase.

In particular, the wavefront analysis mask can simultaneously measure the phase and the intensity of the detected light radiation.

The wavefront analysis mask preferably comprises a diffractive, periodic or aperiodic optical element and/or a refractive optical element. The wavefront analysis mask can be placed close to the detector or close to a plane conjugate with the plane in which the detector extends.

The wavefront analysis mask may be selected in particular from among a mask comprising an array of lenslets, for example a Shack-Hartmann mask, a modified Hartmann mask, for example as described by P. Bon et al. in “Quadriwave lateral shearing interferometry for quantitative phase microscopy of living cells”, Opt. Express, 17, 13080-13094 (2009), and a thin diffuser, for example as described by P. Berto, H. Rigneault and M. Guillon in “Wavefront sensing with a thin diffuser”, Opt. Lett. 42, 5117-5120 (2017).

The light radiation detector preferably comprises a digital camera for acquiring the light radiation, which has preferably interacted with the wavefront analysis mask.

The digital camera may comprise a light sensor, for example CMOS or CCD, for acquiring the light radiation and which measures the intensity of said light radiation.

### Optical Spatial Filter

The area of greatest attenuation and, optionally, the area of least attenuation are adapted to attenuate the intensity of the light radiation.

Preferably, the area of least attenuation does not attenuate the intensity of the light radiation, in order to maintain a maximum light intensity for the measurement.

The area of greatest attenuation induces a greater attenuation of the intensity of the light radiation than the area of least attenuation.

The area of greatest attenuation and/or the area of least attenuation can induce a phase shift between the light radiation that is incident on said areas, respectively, and the light radiation attenuated by said areas so as to amplify the signal-to-noise ratio of the measured phase and intensity signals.

In a variant, the optical spatial filter is adapted to reflect the light radiation, the area of greatest attenuation being semi-reflective. The area of least attenuation may be semi-reflective or, preferably, reflective. The areas of least and greatest attenuation may have different thicknesses, in order to induce different phase shifts in the light radiation they attenuate.

In another variant, the spatial filter is adapted to transmit the light radiation, the area of greatest attenuation being semi-transparent. The area of least attenuation may be semi-transparent or, preferably, transparent. The more the intensity is attenuated, the lower the transmittance. The area of greatest attenuation may have a complex transmittance t defined by the equation t-t₀*e^{-iβ}, where 0<t₀≤0.7, the amplitude to being measured over at least part of the spectrum of the wavelength(s) of the light radiation emitted by the light source, and optionally the phase shift β is such that −1 rad [π]≤β≤1 rad [π], in particular in order to amplify the signal over the phase in absolute terms. The amplitude t₀ of the complex transmittance can be measured by focusing a light beam on the area of greatest attenuation and measuring the attenuation of the intensity of the light beam, thereby giving access to the transmittance T=t₀². The phase shift β can be measured by interferometry. Preferably, T≤0.15, for example T=0.1. The phase shift β may be equal to 0.

The optical spatial filter may comprise a transparent support and a semi-opaque coating that partially covers the support, the area of greatest attenuation being defined by the superposition of the support and the semi-opaque coating.

The transparent support may be made of glass.

The semi-opaque coating may be in the form of at least one disc having a radius Ifs, preferably of less than 0.1*rₚ, where rₚ is the maximum radius of the disc within which the spatial frequencies collected in the Fourier plane are distributed. By way of example, r_{fs}≤100 μm. In the variant in which the imaging optical system is telecentric, the Fourier plane coincides with a pupil plane. Ip then represents the radius of the image of the aperture pupil of the imaging optical system in the Fourier plane.

In a variant, the semi-opaque coating is in the form of a ring. It can have any shape corresponding to the angular spectrum of the illumination.

The semi-opaque coating may be centred on the optical axis of the optical spatial filter.

The semi-opaque coating may have a thickness of less than 100 nm.

The semi-opaque coating may comprise a semi-opaque layer of a metal selected from among gold, silver, aluminium, chromium, titanium and alloys thereof, for example gold.

The semi-opaque coating may comprise a bonding layer sandwiched between and in contact with the support and the semi-opaque layer, for example made of chromium and/or titanium.

The area of greatest attenuation may have a complex transmittance that varies, in particular depending on the polarisation of the light radiation and/or the temperature of said area, and/or that can be modified by the user.

The area of greatest attenuation may comprise a thermochromic material, the transmittance of which can vary depending on the temperature, and/or a polarising material, the transmittance of which can vary depending on the polarisation of the light radiation.

The thermochromic material may be selected from among thermochromic liquid crystals, thermochromic leuco dyes, thermochromic oxides, which are optionally doped, and mixtures thereof, for example selected from the group formed by VO₂, BiVO₄, NbO₂ and mixtures thereof.

The area of greatest attenuation and/or the area of least attenuation may comprise at least one layer made of a material capable of inducing a phase shift between the radiation incident on said areas, respectively, and the radiation attenuated by said areas. By way of example, the areas comprise a layer comprising a polymer, a glass or titanium dioxide. They may comprise a stack of layers made of at least two different materials, for example a stack of a layer of titanium dioxide, a layer of silicon dioxide and another layer of titanium dioxide, or a metasurface.

The area of greatest attenuation and/or the area of least attenuation may comprise a layer made of a birefringent material that induces a phase shift between the radiation incident on said areas, respectively, and the radiation attenuated by said areas, and which can be modulated by rotating the polarisation direction of the light source.

The area of greatest attenuation and/or the area of least attenuation may comprise a layer of a material having a non-zero thermo-optic coefficient which induces a phase shift that varies depending on the temperature, in particular a liquid, for example glycerol, or a polymer, for example polydimethylsiloxane.

The device may comprise a thermal regulation module for modifying the temperature of the area of greatest attenuation and/or the area of least attenuation in order to modify the transmittance of said areas and/or the phase shift induced by said areas. The thermal regulation module may comprise an optical, electrical or magnetic heater, e.g. a Joule heater. By way of example, in a variant in which the area of lesser transmittance comprises a gold layer, the optical heating of said layer modifies the refractive index of the layer, resulting in a variation in the optical phase shift induced by the area of greatest attenuation between the radiation incident on said area and the radiation attenuated by said area. In a variant, the heating may be induced electrically by a resistive wire, in particular a wire made of indium tin oxide (ITO). Using a thermal regulation module makes it possible in particular to vary the phase shift induced by the optical spatial filter in real time so as to optimise the signal-to-noise ratio in both the intensity signal and the phase signal.

The optical spatial filter may comprise a space light modulator (SLM) or a phase-controlled optical grating, in particular in order to modulate the complex transmittance. The space light modulator may optionally be coupled to an opaque mask in order to attenuate part of the radiation diffracted and/or scattered by the object.

The spatial filter may have a plurality of separate areas in which the light radiation is attenuated to the greatest extent.

The device may comprise a plurality of optical spatial filters. The optical spatial filters may be arranged one after another along the propagation path of the light radiation. The optical spatial filters may be removable, the addition or removal of at least one of the optical spatial filters modifying the equivalent complex transmittance of all said spatial filters.

### Imaging Optical System

The imaging optical system may conjugate an object plane with the image plane, the object being located, for example, outside the object plane but close to it. The device allows an object located outside the object plane to be digitally refocused.

The optical system may comprise an objective. In a variant, the optical system preferably comprises one or more additional lenses, in particular convergent lenses, and/or one or more mirrors.

The optical system is preferably stigmatic or substantially stigmatic.

The optical system is preferably aplanatic.

The object numerical aperture NA_{object} of the optical system is preferably between 0.12 and 1.7 to maximise the light radiation diffracted and/or scattered by the object to be detected by the wavefront sensor.

The magnification of the imaging optical system, which is related to the image numerical aperture by the equation NA_{image}=NA_{object}/magnification, is preferably selected to sample, in phase, the image impulse response (PSF_{image}) of the imaging optical system while meeting the Nyquist criterion (>2 measurement points/PSF_{image}).

### Light Source

The light source preferably comprises a light generator for generating the light radiation, for example selected from among a lamp, in particular a halogen lamp, and an intense laser, in particular a supercontinuum laser.

The light radiation emitted by the light source has an angular spectrum that can be shaped by an additional optical system upstream of the object to be imaged in order to distribute the energy of the incident light radiation over the area of greatest attenuation.

In one embodiment example, the area of greatest attenuation is in the form of a disc centred on the optical axis, and the light source may comprise an additional optical system for generating a Köhler illumination. The additional optical system may be arranged between the light generator and the object in the propagation direction of the light radiation, in particular in order to collimate the light radiation incident on the object.

The light source may be configured to emit monochromatic or polychromatic radiation.

When the phase shift, induced by the optical spatial filter, between the radiation incident on said filter and the filtered radiation is non-zero, the light radiation of nominal wavelength λₙₒₘᵢₙₐₗₑ has a spectral range Δλ preferably satisfying the condition Δβ/βₙₒₘᵢₙₐₗ<50%. βₙₒₘᵢₙₐₗ and Δβ correspond to the phase shift and the phase shift variation induced by the optical spatial filter for λₙₒₘᵢₙₐₗ and over the spectral range Δβ, respectively. The spectral extent of the light radiation is preferably set by the way in which the phase shift induced by the optical spatial filter is generated. For a phase shift induced by the optical spatial filter generated by refractive effect,

$$\vert \frac{{λ}_{nominal}}{λ} - 1 \vert < 50 \% .$$

The radiation may be visible, X-ray or infrared.

The light radiation emitted by the light source may be polarised.

The light source may comprise a filter for selecting at least one wavelength of the light radiation emitted by the light generator and/or a filter for polarising said light radiation. The selection filter and/or the polarisation filter may be arranged along the path of the light radiation between the light generator and the object to be imaged.

### Other Units of the Device

The device may comprise an additional digital camera, in particular for measuring the intensity of the light radiation in the Fourier plane of the imaging optical system.

The additional digital camera makes it possible in particular to image the Fourier plane in order to position the optical spatial filter precisely in this plane.

The device may comprise a microscope having an objective, the optical spatial filter either being remote from the microscope or not being remote from the microscope. The microscope may comprise the light source; in particular, the microscope may itself emit a Köhler illumination. The microscope may comprise a sample holder. The microscope may comprise other elements of the optical system, in particular one or more lenses and/or one or more mirrors.

The device may comprise one or more additional optical elements, for example selected from among a lens, in particular a convergent lens, a reflecting mirror, a semi-reflecting mirror, a dichroic mirror and wavelength filters.

### Method

Moreover, the invention relates to a method for acquiring at least one digital image of a sample comprising an object by means of the device according to the invention, the method comprising:
a) emitting incident light radiation directed at the object using the light source,
b) detecting, by the wavefront sensor, the entirety of the light radiation that has interacted with the object, transmitted by the imaging optical system and the optical spatial filter, and
c) processing the signal detected in step b) to quantify a parameter selected from among the phase of the radiation and/or a variation in the phase of the radiation, and optionally to generate a digital image of said parameter.

Preferably, the processing in step c) further comprises quantifying the intensity of the light radiation and preferably generating a digital image of the intensity of the light radiation.

The processing in step c) is quantitative, i.e. it includes correcting the signal detected in step b) by taking into account the effect that the phase shift and attenuation induced by the optical filter have on the value of the parameter.

The sample may comprise one or more objects that are smaller than the resolution of the imaging optical system. The resolution of the imaging optical system is defined by R=λ/(2NA_{object}), where λ is the wavelength of the light radiation and NA_{object} is the object numerical aperture of the imaging optical system.

The object may be transparent or semi-transparent to light radiation. In a variant, the object may be opaque to said radiation.

The sample may be selected from among a biological material comprising a micro-organism, a powder, a biological culture solution, a group of cells or microtissues, an inert material comprising a nanoparticle, or a solution of a mixture of particles. The micro-organism may be a bacterium, a vesicle or a virus.

The light radiation may have a wavelength spectrum as described above.

Lastly, the invention relates to the use of the device for studying one or more nanoparticles or for analysing a chemical reaction, an electrochemical reaction, a photografting reaction or a photopolymerisation reaction, for mapping a temperature distribution, or for specifically detecting molecules by way of their absorption in a pump-probe system.

### BRIEF DESCRIPTION OF THE DRAWINGS

The invention can be better understood by reading the following detailed description of non-limiting embodiments of the invention and studying the accompanying drawings, in which:

FIG. 1A is a schematic view of part of an example device according to the invention,

FIG. 1B is a schematic view of part of an example wavefront sensor,

FIGS. 2A and 2B schematically show the spatial distributions of the incident and scattered fields in the Fourier plane for the device according to the invention, without and with the spatial filter being present, respectively, and FIGS. 2C, 2D and 2E show the complex representations of the incident, scattered and total fields, FIG. 2C showing the case for FIG. 2A and FIGS. 2D and 2E showing the case for FIG. 2B,

FIGS. 3A, 3B and 3C show the results of digital simulations of the phase images, and FIGS. 3D, 3E and 3F show the digital simulations of the intensity images of a spherical object without filtering (3A and 3D), with filtering (3B and 3E) and with filtering and quantitative processing (3C and 3F), respectively,

FIGS. 4A and 4B show maps of the simulated phase gain and intensity contrast values plotted against the transmittance and the phase shift of the spatial filter, respectively,

FIGS. 5A and 5B show maps of the simulated relative phase and intensity errors plotted against the transmittance and the phase shift of the spatial filter,

FIGS. 6A and 6B show the simulated relative phase and intensity errors plotted against the ratio between the radius of the spatial filter and the radius of the exit pupil of the optical system,

FIG. 7A is an experimental image of the Fourier plane, FIGS. 7B and 7C each show the image and the profile of the incident radiation in the Fourier plane, with and without a filter, respectively,

FIGS. 8A, 8B and 8C each show intensity and phase images as well as intensity and phase profiles according to the segments shown in the intensity and phase images,

FIGS. 9A and 9B show enlargements of the phase images of FIGS. 8A and 8C,

FIGS. 10A, 10B and 10C show three different angular spectra of the light radiation in the Fourier plane, and FIGS. 10D, 10E and 10F show the corresponding optical spatial filters,

FIG. 11A is a schematic view of part of an alternative embodiment of the optical spatial filter, and FIG. 11B shows the complex representations of the incident, scattered and total fields after filtering by the optical spatial filter of FIG. 11A,

FIGS. 12A and 12B are experimental intensity and phase images, respectively, of the same object when the optical spatial filter of FIG. 11A is not present (group 1 on the left) and when the optical spatial filter of FIG. 11A is present (group 2 on the right), for different values of applied variable phase shift, and

FIGS. 13A and 13B show the curve of the intensity contrast and the phase gain, respectively, corresponding to FIGS. 12A and 12B.

### DETAILED DESCRIPTION

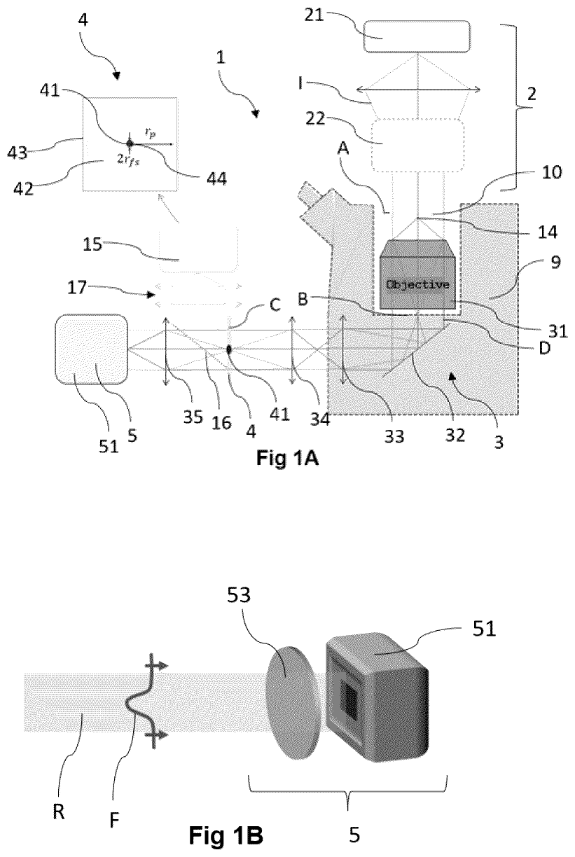

FIG. 1A shows an example quantitative phase imaging device 1 according to the invention. The device comprises a light source 2, a telecentric imaging optical system 3, an optical spatial filter 4 and a wavefront sensor 5. Part of the optical system 3 is housed in a microscope 9. This part of the optical system 3 comprises an objective 31, a mirror 32 and a tube lens 33. The microscope 9 also comprises a sample holder 10 arranged in the object focal plane A of the optical system 3.

To image an object, the user of the device 1 places a sample 14 comprising the object on the sample holder 10.

The light source 2 comprises a light generator 21 and may comprise, between the light generator 21 and the object focal plane A, an optical system 22 for creating a Köhler-type illumination at the object focal plane A, and therefore at the sample 14 if necessary. The incident radiation I, coming from the source 2, is thus collimated and impinges normally in the object focal plane A, on the sample holder 10. Part D of this radiation is then scattered by the sample 14.

In the example shown, the image focal plane B of the objective 31, corresponding to the Fourier plane of the optical system, is inaccessible because it is located inside the microscope 9. Advantageously, the spatial filter 4 can be arranged in a plane C conjugate with the Fourier plane B, which plane is shifted after the tube lens 33 by a convergent lens 34 of the imaging optical system 3.

The conjugate plane C thus corresponds to the Fourier plane of the optical system 3.

As shown in FIG. 1B, the wavefront sensor 5 may comprise a digital camera 51 and a wavefront analysis mask 53, for example of the Shack-Hartman type, arranged upstream of the camera 51. Radiation R characterised by its wavefront F arrives at the wavefront analysis mask 53 before being detected by the camera 51.

The wavefront analysis mask 53 can modify the path of the light radiation, and the complex amplitude variation generated makes it possible to simultaneously measure the phase and the intensity of the light radiation.

Thus, the wavefront sensor shown in FIG. 1B measures the intensity and phase of the entirety of the light radiation it receives.

In the example shown in FIG. 1A, the wavefront sensor 5 is preceded, in the propagation direction of the light radiation, by a convergent lens 35, which forms part of the imaging optical system 3 and allows the sample 14 to be imaged on the digital camera 51.

The device 1 also comprises an additional camera 15 for imaging the Fourier plane C by means of a pivoting or semi-transparent mirror 16 and a dual-lens optical system 17. The spatial filter 4 can thus be positioned precisely in the Fourier plane C, centred on the optical axis, for example using a translation stage (not shown).

The optical spatial filter 4 has an area of greatest attenuation 41 and an area of least attenuation 42. In the example shown, the spatial filter comprises a support 43 in the form of a transparent plate, for example made of glass and of a square shape, covered with a metal coating 44 in the form of a disc of radius Ifs arranged at the centre of the plate.

The area of least attenuation 42 may be defined by the portion of the support 43 not covered by the coating 44, and the area of greatest attenuation is defined by the superposition of the support 43 and the coating 44.

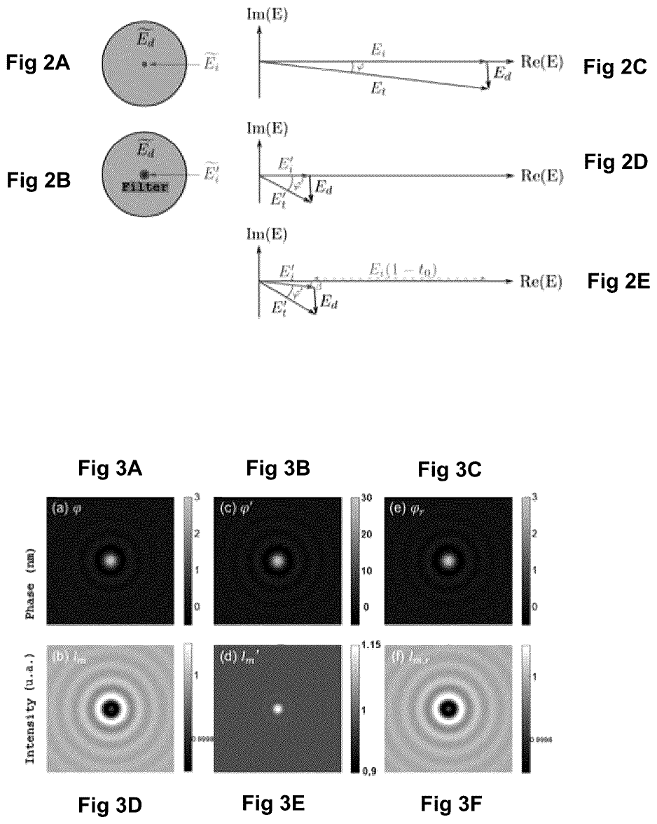

FIG. 2A schematically shows the spatial distributions in the Fourier plane of the incident and scattered electromagnetic fields obtained by the device 1 according to the invention when the spatial filter 4 is not present. When a sample 14 is placed in the object focal plane A on the sample holder 10 of the device without a spatial filter 4, the incident electromagnetic field corresponding to the incident radiation I not impacted by the sample is denoted by Eᵢ, and the scattered electromagnetic field corresponding to the scattered radiation D is denoted by E_{d}. \tilde{E}_{d} and \tilde{E}ᵢ respectively represent the spatial Fourier transforms of the scattered fields E_{d} and Eᵢ.

Where the sample 14 is a semi-transparent, non-absorbent, low-scatter object, the total electromagnetic field Eₜ is expressed by equation (1):

$${E}_{t} = {E}_{i} + {E}_{d} \qquad ( 1 )$$

In this example, since the incident radiation I is collimated at the sample 14, it has a point distribution at the centre of the Fourier plane C corresponding to the image of the pupil of the optical system 3.

When the sample 14 is smaller than the wavelength(s) of the incident radiation, for example smaller than 100 nm, the radiation D is scattered in a quasi-isotropic manner. It is thus homogeneously distributed on the image of the pupil of the optical system 3 in the Fourier plane C.

The fields Eᵢ and E_{d} can be observed in the Fourier plane C as shown schematically in FIG. 2A, by means of the additional camera 15 which images the Fourier plane C. The field E_{d} fills the Fourier plane C while the field Eᵢ is in this case concentrated at a point at the centre of the Fourier plane C. More generally, the field Eᵢ is distributed according to the angular distribution of the light radiation I emitted by the light source 2.

In the case of a low-scatter object, and as shown in FIG. 2C, the modulus |E_{d}| of the scattered field is small compared with the modulus of the incident field |Eᵢ|. For example, it is more than 1000 times less than the modulus of the incident field |Eᵢ|. It can then be considered that the total field Eₜ is equal to the incident field Eᵢ phase-shifted by a phase shift φ, hence equation (2):

$${E}_{t} = {E}_{i} {e}^{- i φ} \qquad ( 2 )$$

For biological objects, such as vesicles or viruses, or even nanoparticles, the phase shift φ is small, in particular less than 0.05 rad, such that Taylor's development can be used in φ, hence equation (4):

$${E}_{t} \approx {E}_{i} ( 1 - i φ ) \qquad ( 4 )$$

Through identification between equations (1) and (4), the scattered field E_{d} can be written, according to equation (5), as the incident field Eᵢ attenuated by φ and phase-shifted by approximately

$$\frac{π}{2} :$$

$${E}_{d} \approx - i φ {E}_{i} \qquad ( 5 )$$

FIG. 2C shows the complex representation of the incident Eᵢ, scattered E_{d} and total Eₜ fields obtained using the device 1 without a spatial filter. This figure shows the phase shift close to

$$\frac{π}{2}$$

of the scattered field E_{d} relative to the incident field Eᵢ.

In the case of the device according to the invention when the optical spatial filter 4 is present in the Fourier plane C, Eᵢ′ is the contribution made by the incident electromagnetic field, corresponding to the incident radiation I after transmission by the spatial filter 4, to the total electromagnetic field Eₜ′ reaching the wavefront sensor 5, and E_{d}′ is the contribution of the scattered electromagnetic field, corresponding to the scattered radiation D after being transmitted by the spatial filter 4, to said total electromagnetic field.

Where the sample 14 is a semi-transparent, non-absorbent, low-scatter object, the following equation (6) can be defined:

$${E}_{t}^{′} = {E}_{i}^{′} + {E}_{d}^{′} \qquad ( 6 )$$

The complex transmittance t of the area of lesser transmittance is defined as t=t₀e^{-iβ}.

The radius r_{fs} of the area of lesser transmittance is preferably at least 5 times less than the radius rₚ of the image of the pupil of the optical system 3 in the Fourier plane. Thus, the area of greatest attenuation affects only the incident field and not the scattered field, as can be seen in FIG. 2B. The following equations (7) to (9) may thus be written:

$${E}_{i}^{′} = t \cdot {E}_{i} = {t}_{0} {e}^{- i β} \cdot {E}_{i} \qquad ( 7 )$$

$${E}_{d}^{′} = {E}_{d} \qquad ( 8 )$$

$${E}_{t}^{′} = {E}_{i}^{′} + {E}_{d}^{′} = {t}_{0} {E}_{i} {e}^{- i β} + {E}_{d} \qquad ( 9 )$$

FIGS. 2D and 2E show the complex representation of the incident field after filtering

$$\\ {E}_{i}^{′} ,$$

scattered field after filtering E_{d} and total field after filtering Eₜ′, where β is zero and where β is non-zero, respectively. In particular, it is possible to see the decrease in the amplitude of the incident field after filtering

$$\\ {E}_{i}^{′}$$

compared with the amplitude or the unfiltered incident field Eᵢ shown in FIG. 2C. The amplitude to of the transmittance is selected such that |Eᵢ′|=|tEᵢ|≈|E_{d}| in order to achieve the best compromise between the attenuation of Eᵢ and the signal level necessary for good phase reconstruction. Preferably, 0<t₀<0.7.

The area of greatest attenuation is semi-transparent. Complete cancellation of the incident field Eᵢ′=0 by an opaque area of greatest attenuation would produce dark-field illumination but would prevent the phase of the wavefront from being defined over the entire field of view.

The total field transmitted Eₜ′ bears a new phase shift φ′>φ relative to the field Eᵢ′.

The phase shift φ induced by the sample 14 can be quantified from the measurement of the intensity and the phase of the field Eₜ′.

By combining equations (1) and (8), equation (10) is obtained:

$${E}_{t} = {E}_{t}^{′} + ( 1 - {t}_{0} {e}^{- i β} ) {E}_{i} \qquad ( 10 )$$

Iₜ and Iₜ′ are the respective relative intensities of the total fields Eₜ in the case of a device 1 not having a spatial filter 4, and after filtering Eₜ′ in the case of a device 1 having a spatial filter 4. Equations (11) and (12) can be formulated:

$${E}_{t} = \sqrt{{I}_{t}} {e}^{- i φ} \qquad ( 11 )$$

$${E}_{t}^{′} = \sqrt{{I}_{t}^{′}} {e}^{- i ( {φ}^{′} + β )} \qquad ( 12 )$$

and so can equation (13) starting from equation (10):

$$\sqrt{{I}_{t}} {e}^{- i φ} = \sqrt{{I}_{t}^{′}} {e}^{- i ( {φ}^{′} + β )} + ( 1 - {t}_{0} {e}^{- i β} ) {E}_{i} \qquad ( 13 )$$

The wavefront sensor 5 measures a relative intensity, i.e. the ratio between a reference image when no sample is present and an image when the sample 14 is present. The intensity ratios Iₘ and Iₘ′ defined by equations (14) and (15) can thus be measured:

$${I}_{m} = \frac{{\vert {E}_{t} \vert}^{2}}{{\vert {E}_{i} \vert}^{2}} = \frac{{I}_{t}}{{\vert {E}_{i} \vert}^{2}} \qquad ( 14 )$$

$${I}_{m}^{′} = \frac{{\vert {E}_{t}^{′} \vert}^{2}}{{\vert {E}_{i}^{′} \vert}^{2}} = \frac{{I}_{t}^{′}}{{t}_{0}^{2} {\vert {E}_{i} \vert}^{2}} \qquad ( 15 )$$

Equation (16) can then be formulated from equation (13):

$$\sqrt{{I}_{m}} {e}^{- i φ} = {t}_{0} \sqrt{{I}_{m}^{′}} {e}^{- i ( {φ}^{′} + β )} + 1 - {t}_{0} {e}^{- i β} \qquad ( 16 )$$

By knowing the complex transmittance of the spatial filter 4, and on the basis of the measured parameters \sqrt{Iₘ′} and φ′ when the spatial filter 4 is present, the phase shift φ and the absorption Iₘ induced by the scattering object of the sample 14 can be quantified.

The implementation of the device 1 has been digitally simulated in order to determine the optimal use conditions. Such simulations were carried out in accordance with the method set out in the article P. Bon, B. Wattellier, and S. Monneret, “Modeling quantitative phase image formation under tilted illuminations”, Opt. Lett. 37, 1718 (2012).

The sample 14 studied is a polystyrene bead having an optical index of 1.62, immersed in water having an optical index of 1.33. The sample 14 was illuminated by monochromatic light radiation of wavelength λ=440 nm. The objective 31 used had a numerical aperture of 1.4.

Spatial filtering was simulated on the field \tilde{E}ₜ, the spatial Fourier transform of the total field Eₜ.

The simulated electromagnetic field included in a disc of radius r_{fs} (the radius of the area of greatest attenuation 41 of the spatial filter 4) was then multiplied by the complex transmittance t₀e^{-iβ} of the spatial filter 4 to simulate the interaction with said spatial filter 4. The field area outside a disc of radius rₚ (the radius of the image of the pupil of the optical system 3 in the Fourier plane C) was set to 0 to simulate the finite numerical aperture of the optical system 3. The field \tilde{E}ₜ′ was thus simulated, according to equation (17):

$${\tilde{E}}_{t}^{′} = \{ \begin{matrix}{t}_{0} {e}^{- i β} {\tilde{E}}_{t} & for \vert k \vert \leq \frac{{r}_{fs}}{{r}_{p}} {k}_{max} \\ {\tilde{E}}_{t} & for \vert k \vert > \frac{{r}_{fs}}{{r}_{p}} {k}_{max} \\ 0 & for \vert k \vert > {k}_{max} = NA / λ\end{matrix} \qquad ( 17 )$$

where k is the image vectors in the pupil, NA is the numerical aperture of the optical system 3 and λ is the wavelength of the light radiation.

The value of the total field after filtering Eₜ′, measurable on the wavefront sensor 5, was calculated by performing an inverse spatial Fourier transform of this field \tilde{E}ₜ′.

The intensity

$$\\ {I}_{m}^{′}$$

and phrase φ′, calculated by

$$\frac{{\vert {E}_{t}^{′} \vert}^{2}}{{t}_{0}^{2}}$$

and arg (Eₜ′), respectively, are shown in the intensity and phase images of FIGS. 3E and 3B, respectively. They were calculated by considering t₀=0.1, β=0 and

$$\frac{{r}_{fs}}{{r}_{p}} = 7 \% .$$

FIG. 5B snows that an amplification of the measured phase φ′ is obtained, the value of which is up to more than ten times greater than the value of the phase shift φ calculated when no spatial filter is present, as shown in FIG. 3A. The intensity map of FIG. 3E corresponds to a partially dark-field image in which the light scattered by the object, in the centre of the figure, predominates over the incident light.

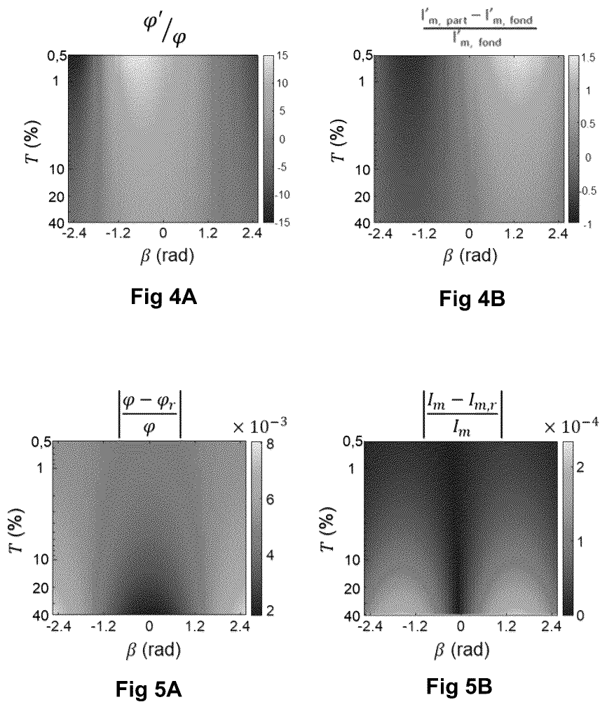

FIG. 4A shows the in-phase amplifications, and FIG. 4B shows the simulated intensity contrast amplifications plotted against the transmittance T and the phase shift β of the spatial filter 4, for

$$\frac{{r}_{fs}}{{r}_{p}} = 7 \% .$$

For a phase shift β induced by the spatial filter 4 close to 0 [2π], the phase amplification is greater the lower the transmittance T. This means that the device 1 operates optimally when the ratio

$$\vert \frac{{E}_{d}}{{E}_{i}} \vert$$

is balanced.

The calculated intensity

$${I}_{m}^{′}$$

and phase φ′ were subjected to processing for returning to the quantitative parameters, according to equation (18):

$$\sqrt{{I}_{m , r}} {e}^{- i {φ}_{r}} = {t}_{0} \sqrt{{I}_{m}^{′}} {e}^{- i ( {φ}^{′} + β )} + 1 - {t}_{0} {e}^{- i β} \qquad ( 18 )$$

By comparing the actual phase and intensity values (φ, Iₘ) with those found after filtering and quantitative processing (φᵣ, I_{m,r}), the relative error induced by the spatial filter 4 was estimated and is particularly low. It can be seen, by comparing FIG. 3C with FIG. 3A, FIG. 3F and FIG. 3D, that the phase and intensity values found (φᵣ, I_{m,r}) are almost identical to the actual phase and intensity values (φ, Iₘ).

This comparison reflects the proper functioning of the quantitative processing for returning to the values when no filter is present.

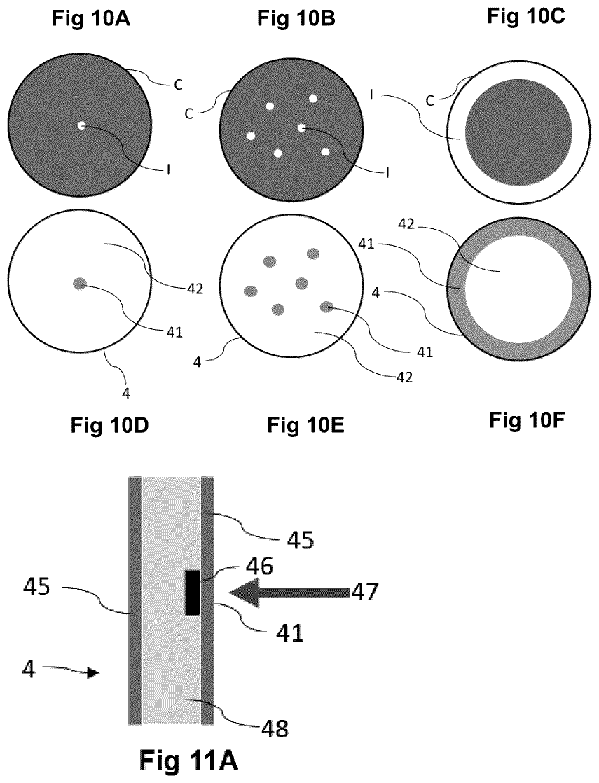

As shown in FIG. 5, modifying the complex transmittance of the spatial filter 4 leads to relative errors of less than 10⁻² for the phase (FIG. 5A) and 10⁻⁴ for the intensity (FIG. 5B).

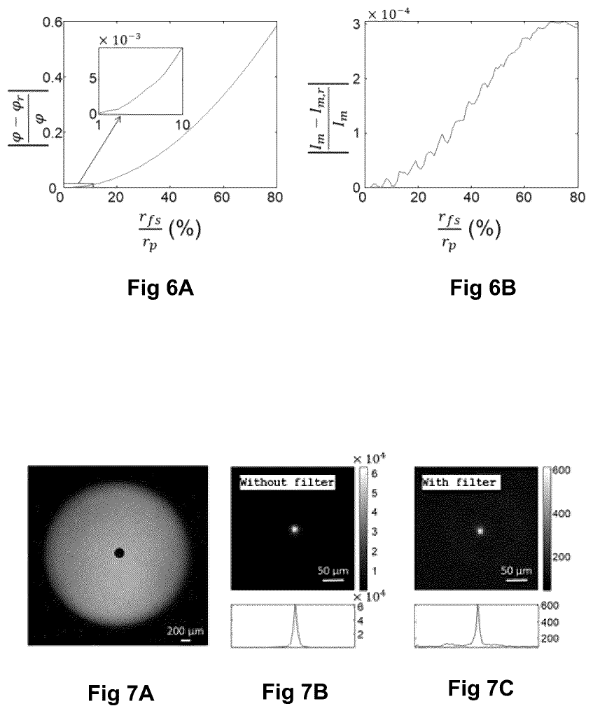

FIG. 6 shows the effect, on the relative phase and intensity errors, of the ratio

$$\frac{{r}_{fs}}{{r}_{p}}$$

of the radius of the spatial filter 4 to the radius of the image of the pupil of the optical the phase errors are system 3 in the Fourier plane C. It can be seen that below

$$\frac{{r}_{fs}}{{r}_{p}} = 10 \% ,$$

the phase errors are less than 1% (FIG. 6A) and the intensity errors are less than 10⁻³% (FIG. 6B). This value of the ratio is then established as the limit below which it is considered reasonable to assume that the presence of the spatial filter 4 does not modify the scattered field E_{d}.

### Example 1

The microscope 9 used was an Olympus IX71 commercial microscope equipped with a 60× microscope objective having a numerical aperture of 0.9 (Olympus UPlanFLN).

The sample 14 was illuminated by means of the native Köhler illumination of the microscope 9 (halogen lamp), filtered by wavelength.

The wavefront sensor 5 was an ID4L analyser (quadriwave lateral shearing interferometer) composed of an Andor Zyla 5.5 camera and a 2D diffraction grating of 10 μm periodicity, optimised for the wavelength 650 nm. This array was re-imaged on the camera using a 2× magnification telescope, composed of two achromatic lenses. The effective distance between the diffraction grating and the camera was d=1.2 mm.

The area of greatest attenuation 41 of the spatial filter 4 was an 80-nm gold disc on 5 nm of chromium, of radius r_{fs}=100 μm, deposited on a glass slide using electron beam evaporation. The transmittance of the optical spatial filter was measured experimentally at T=7%, λ=440 and 550 nm, by measuring, without a sample present, the intensity signal I₁ without a filter and the intensity signal I₂ with a filter, in order to deduce T=I₂/I₁ therefrom. The phase shift β=0.5 rad was measured by interferometry.

FIG. 7A shows an image of the Fourier plane of the experimental device acquired by the additional camera 15. The white disc corresponds to the radiation D scattered by a sample formed by a superposition of sheets of paper, over the entire image of the pupil of the optical system 3 in the Fourier plane C, and the black disc in the middle corresponds to the spatial filter 4. Comparing FIGS. 7B and 7C reveals the effect that the spatial filter 4 has on the intensity of the incident radiation I.

The sample 14 studied was a set of polystyrene beads of optical index n_{poly}=1.62 and diameter e=100 nm immersed in water of optical index n_{water}=1.33.

FIG. 8 presents the results obtained without a spatial filter 4 and with a spatial filter 4, as well as with quantitative reconstruction, using equation 16 starting from the filtered images. FIG. 8A shows the results obtained without a spatial filter 4, FIG. 8B shows the results obtained with a spatial filter 4 and FIG. 8C shows the results obtained with a spatial filter 4 and following quantitative processing on the basis of the measurements.

Experimentally, a gain of a factor of about 3 of the phase signal is measured, from φ=3.5 nm without a spatial filter to φ′=11 nm with a spatial filter, close to the theoretical value simulated by the model and shown in FIG. 4A. The phase values are expressed in nm because they refer to the difference in optical path difference δ, a quantity that can be related to the phase in radian by the equation:

$$φ = 2 π \frac{δ}{λ} ,$$

where λ is the wavelength of the radiation.

Since the modulus of the field scattered by the beads is very low compared with that of the incident field, the beads do not appear in the intensity image without a filter, shown in FIG. 8A. FIG. 8B shows that the presence of the spatial filter 4 produces a partially dark-field configuration and allows the beads to be emphasised with a contrast of 0.2, a value which is also close to the expected theoretical value found in FIG. 4B.

After quantitative reconstruction, the reconstructed intensity and phase values, which can be seen in FIG. 8C, are identical to the raw intensity and phase values but with a clear gain in the signal-to-noise ratio.

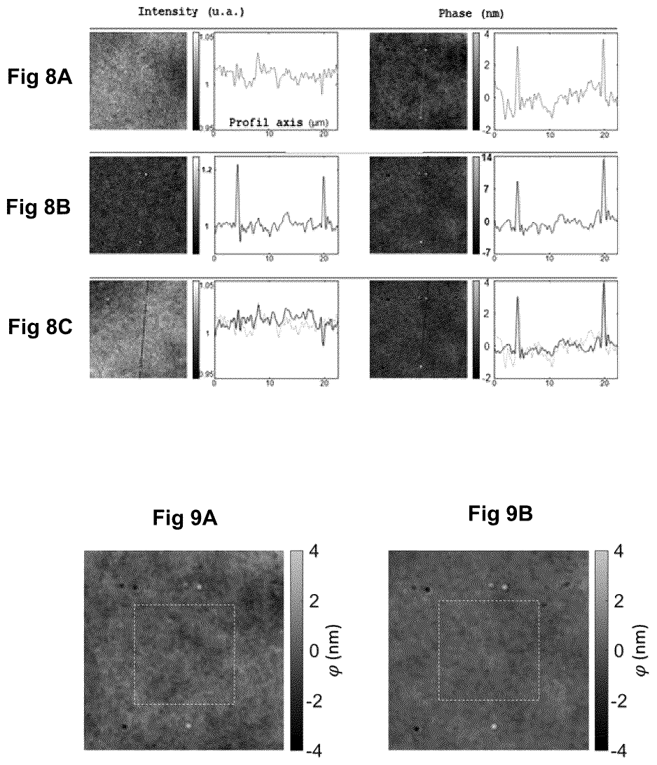

FIG. 9A is an enlargement of the phase image of FIG. 8B, and FIG. 9B is an enlargement of the phase image of FIG. 8C. The noise is calculated over the areas demarcated by dotted lines in FIGS. 9A and 9B. An RMS phase noise of σ_{φ}=0.42 nm is observed for the measurements without a spatial filter in FIG. 9A, and an RMS phase noise of σ_{φ}=0.29 nm is observed for the filtered and then reconstructed measurements in FIG. 9B.

In a variant, the angular spectrum of the incident light radiation I is a disc centred in the Fourier plane C, as can be seen in FIG. 10A, the white area corresponding to the incident light radiation I. The area of greatest attenuation 41 is a disc at the centre of the optical spatial filter 4, as shown in FIG. 10D, the grey area corresponding to the area of greatest attenuation 41.

In a variant, the angular spectrum of the incident light radiation I is shown in the Fourier plane C by a plurality of spaced-apart discs, as can be seen in FIG. 10B, the white areas corresponding to the incident light radiation I. The area of greatest attenuation 41 is composed of a plurality of discs distributed over the optical spatial filter 4 in the same way as the incident light radiation I in the Fourier plane C, as shown in FIG. 10E, the grey areas corresponding to the area of greatest attenuation 41.

In another variant, the angular spectrum of the incident light radiation I is a ring in the Fourier plane C, as can be seen in FIG. 10A, the white area corresponding to the incident light radiation I. The area of greatest attenuation 41 is a corresponding ring on the optical spatial filter 4, as shown in FIG. 10D, the grey area corresponding to the area of greatest attenuation 41.

### Example 2

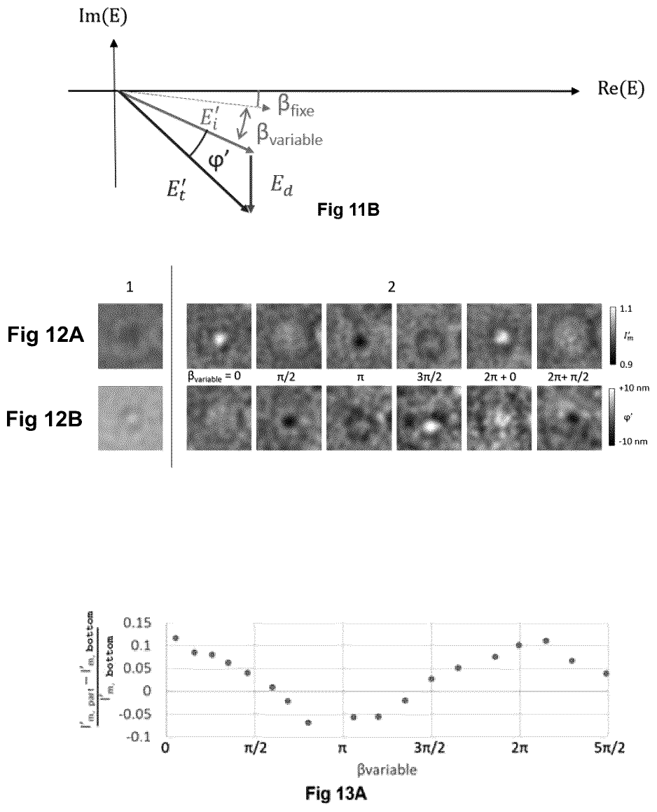

The same sample 14 and the same device as for example 1 were used, except for the optical spatial filter 4. In this case, said filter, which can be seen in FIG. 11A, had an area of greatest attenuation 41 comprising a chamber 48 that contained a medium having a high thermo-optic coefficient dn/dT, such as glycerol, for which dn/dT=−2.7□10⁻⁴, in contact with the above-described 80-nm-thick gold disc 46, the chamber 48 and the disc 46 being between two glass plates 45 of the optical spatial filter 4.

By means of a focused laser heating system 47, the chamber 48 made it possible to vary the phase shift induced by the optical spatial filter 4 on the incident field Eᵢ. The total phase shift βₜₒₜₐₗ induced by the optical spatial filter 4 on the incident field Eᵢ was then the sum of a variable component β_{variable} and a fixed component β_{fixed}, as can be seen in FIG. 11B, where

$${E}_{i}^{′} ,$$

E_{d} and Eₜ′ are the complex representations of the incident field after filtering, scattered field after filtering and total field after filtering, respectively. The phase shift β_{variable} allowed the values of the phase shift φ′ and intensity |E′ₜ|² to be optimised.

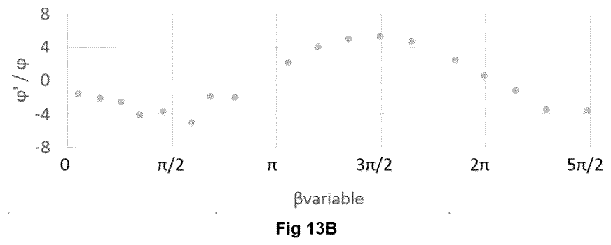

FIGS. 12A and 12B show the experimental intensity and phase images, respectively, with no filter present (group 1 on the left) and with the optical spatial filter 4 present for different values of β_{variable} obtained by heating the thermosensitive chamber (group 2 on the right). The curves of FIGS. 13A and 13B show the variation in the intensity and phase contrasts, respectively, plotted against the phase shift induced by the optical spatial filter 4. It should be noted that the results of the simulations presented in FIGS. 4A and 4B are found experimentally, for a transmittance T equal to 7%.

Using the chamber 48 and the heating system 47 makes it possible to vary the phase shift induced by the optical spatial filter 4 in real time, so as to optimise the signal-to-noise ratio in both the intensity signal and the phase signal.

1-28. (canceled)

29. A quantitative phase imaging device comprising:
an imaging optical system for imaging an object in an image plane,
a light source for emitting light radiation (I) over at least part of the Fourier plane of the imaging optical system,
an optical spatial filter extending in the Fourier plane of the imaging optical system and comprising an area in which the light radiation is attenuated to the least extent and an area in which the light radiation is attenuated to the greatest extent,
a wavefront sensor for measuring, in the image plane, the intensity and the phase of the electromagnetic field associated with the light radiation that was emitted by the light source, has passed through the imaging optical system and the optical spatial filter and of which at least part has interacted with the object, in order to quantify the phase induced by the object,
the light source, the imaging optical system and the optical spatial filter being arranged so that, when the object to be imaged is absent, the light radiation is focused on the area of greatest attenuation.

30. The device according to claim 29, the area of greatest attenuation having a complex transmittance t defined by the equation t=t₀*e^{-iβ}, where 0<t₀≤0.7, the amplitude to being measured over at least part of the spectrum of wavelength(s) of the light radiation emitted by the light source, and optionally the phase shift β being such that −1 rad [π]≤β≤1 rad [π], in particular in order to amplify the signal over the phase in absolute terms.

31. The device according to claim 29, the optical spatial filter comprising a transparent support and a semi-opaque coating partially covering the support, the area of greatest attenuation being defined by the superposition of the support and the semi-opaque coating.

32. The device according to claim 31, the semi-opaque coating being in the form of at least one disc having a radius ffs, preferably of less than 0.1*rₚ, where rₚ is the maximum radius of the disc within which the spatial frequencies collected in the Fourier plane are distributed, for example r_{fs}≤100 μm.

33. The device according to claim 29, the wavefront sensor comprising a light radiation detector and, a wavefront analysis mask arranged in front of the detector along the optical path of the light radiation, in order to determine the spatial distribution of the gradient of the phase of the light radiation or of a signal proportional to said phase.

34. The device according to claim 33, the wavefront analysis mask being selected from among a mask comprising an array of lenslets, for example a Shack-Hartmann mask, a modified Hartmann mask and a thin diffuser.

35. The device according to claim 29, comprising a microscope having an objective, the microscope optionally comprising a sample holder and/or the light source, the optical spatial filter being remote from the microscope.

36. The device according to claim 29, the area of greatest attenuation having a complex transmittance that varies, in particular depending on the polarisation of the light radiation and/or the temperature of said area, and/or that can be modified by the user.

37. The device according to claim 36, the area of greatest attenuation comprising a thermochromic and/or polarising material.

38. The device according to claim 29, the area of greatest attenuation and/or the area of least attenuation comprising at least one layer made of a material capable of inducing a phase shift between the radiation incident on said areas, respectively, and the radiation attenuated by said areas, for example a layer comprising a polymer, a glass or titanium dioxide, a stack of layers, or a metasurface.

39. The device according to claim 38, the area of greatest attenuation and/or the area of least attenuation comprising a layer of a birefringent material.

40. The device according to claim 38, the area of greatest attenuation and/or the area of least attenuation comprising a layer of a material having a non-zero thermo-optic coefficient, in particular a liquid, for example glycerol, or a polymer, for example polydimethylsiloxane.

41. The device according to claim 29, comprising a thermal regulation module for modifying the temperature of the area of greatest attenuation and/or the area of least attenuation in order to modify the transmittance of said areas and/or the phase shift induced by said areas.

42. The device according to the claim 41, the area of greatest attenuation being in the form of a disc centred on the optical axis, and the light source comprising an additional optical system for generating a Köhler illumination, the additional optical system being arranged between the light generator and the object in the propagation direction of the light radiation, in particular in order to collimate the light radiation incident on the object.

43. A method for acquiring at least one digital image of a sample comprising an object by means of the device according to claim 29, the method comprising:
a) emitting incident light radiation directed at the object using the light source,
b) detecting, by the wavefront sensor, the entirety of the light radiation that has interacted with the object, transmitted by the imaging optical system and the optical spatial filter, and
c) processing the signal detected in step b) to quantify a parameter selected from among the phase of the light radiation and/or a variation in the phase of the light radiation, and optionally to generate a digital image of said parameter.

44. The method according to claim 43, the processing in step c) further comprising quantifying the intensity of the light radiation and preferably generating a digital image of the intensity of the light radiation.
